(19) United States
(12) Patent Application Publication
(10) Pub. No.: US 2008/0133346 A1
(43) Pub. Date: Jun. 5, 2008

(54) Human responses and rewards for requests at web scale

(76) Inventors: Jyh-Herng Chow, San Jose, CA (US); Dmitry Pavlov, San Jose, CA (US); Qi Lu, Saratoga, CA (US)

Correspondence Address: BRINKS HOFER GILSON & LIONE / YAHOO! OVERTURE, P.O. BOX 10395, CHICAGO, IL, 60610, US

(21) Appl. No.: 11/607,296

(22) Filed: Nov. 30, 2006

(51) Int. Cl. G06Q 30/00

(52) U.S. Cl. 705/14

(57) ABSTRACT

A system and method are disclosed for receiving human responses to various requests that may require a human review. A request may be submitted for completion by at least one of a plurality of available users. Upon completion of the request, the user may be eligible for a reward if the requestor approves of the completed request. The reward may include a portion of the revenue generated by the completed request.

### BACKGROUND

Various web sites and web portals may crawl the web or receive a data feed from other sources. The data obtained may be unstructured and not directly usable. Accordingly, non-trivial techniques may be used to extract useful and relevant information, such as attribute extraction or classification of the data or web pages. Machine learning (“ML”) techniques may be used in certain applications; however, ML techniques, such as supervised learning algorithms may require extensive training data, in order to train a model which can be used to automatically perform a requested task. Extensive training data may require human response or human review and be difficult to obtain and expensive. In addition, human review may be unreliable and produce inaccurate results.

The acquisition of labeled data may be an example of an application in need of human review. Labeling data is labor intensive and expensive in terms of time and resources. To address this issue, ML applications may use techniques, such as pattern matching, to develop training data. However, this requires expert knowledge of the data, and the accuracy of such techniques is often unverified. Human review of any ML applications may still result in mistakes. The high cost of manual labeling, usually means the labeling is done only once. Incorrectly labeled data in the training data, not only introduces noise, but also reduces the accuracy of the trained ML model. Therefore, a need exists for an improved system of utilizing human review for certain tasks and applications.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

FIG. 1 is a diagram illustrating one embodiment of a system which allows for human responses;

FIG. 2 is a diagram illustrating another embodiment of a system which allows for human responses;

FIG. 3 is a flow chart illustrating the operation of allowing for human responses according to one embodiment;

FIG. 4 is a flow chart illustrating the operation of allowing for human responses according to another embodiment;

FIG. 5 is a diagram illustrating potential rewards for use with the disclosed embodiments; and

FIG. 6 is an illustration of a general computer system for use with the disclosed embodiments.

### DETAILED DESCRIPTION

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims and be defined by the following claims. Nothing in this section should be taken as a limitation on those claims. Further aspects and advantages are discussed below in conjunction with the preferred embodiments.

By way of introduction, the embodiments described below include a system and method for organizing and distributing requests to individuals over the web, wherein the human responses to the requests may be rewarded. The requests may be referred to as a job, task, work, activity, assignment, review, or human review throughout the disclosure. Likewise, a completed request may be referred to as a response or a human response. The requests may be jobs that users can complete to receive a variety of rewards. One reward may be receiving a share of the revenue generated as a result of completing the request.

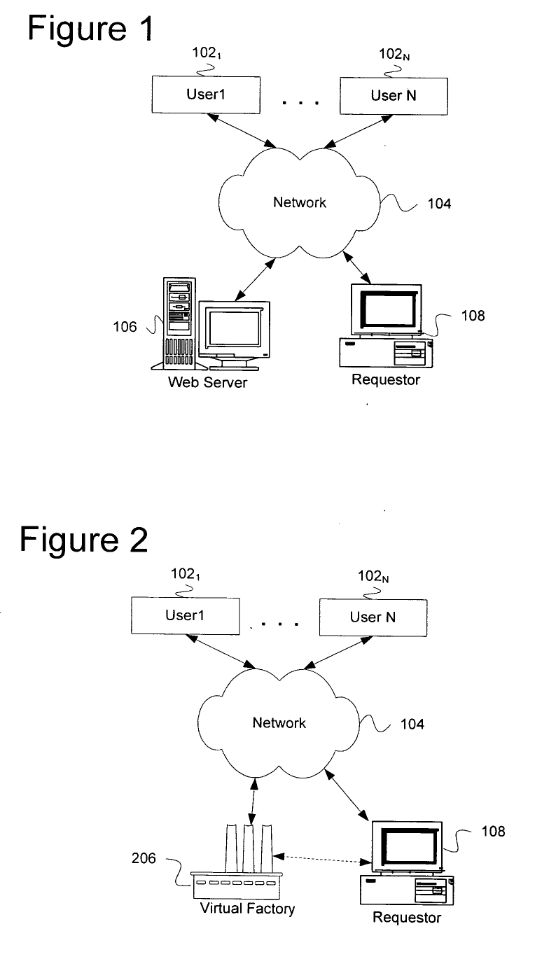

FIG. 1 is a diagram illustrating one embodiment allowing for human responses to requests. A plurality of N users are coupled with a network 104 as represented by user1 102₁ and user N 102_{N}. A web server 106 and a requester 108 are coupled with the network 104 and may be coupled with the users 102. Herein, the phrase “coupled with” is defined to mean directly connected to or indirectly connected through one or more intermediate components. Such intermediate components may include both hardware and software based components.

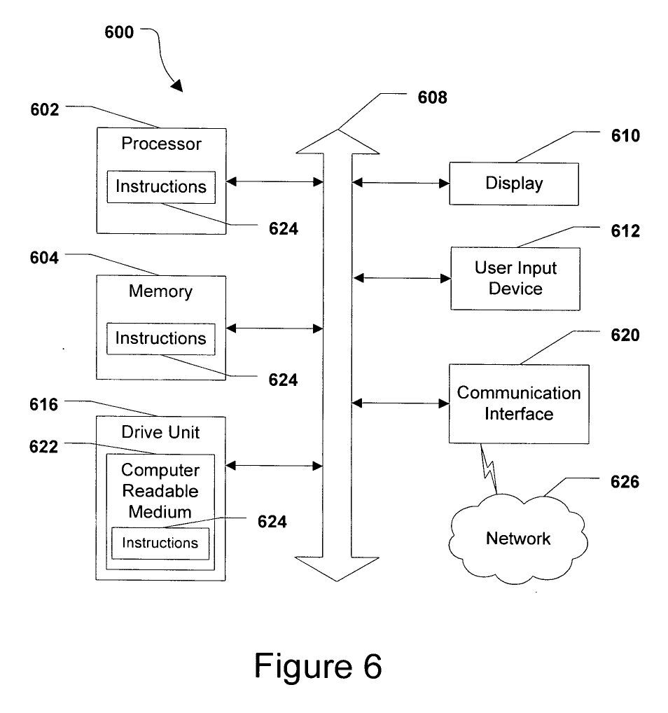

As shown, there may be N users from user1 102₁ through user N 102_{N}. N may be any number, including one, to represent users that are logged into the network 104. Users 102 may also be referred to as participants, individuals, or workers. In one embodiment, a user 102 may be a consumer of goods or services that is requesting information, or conducting a transaction. Alternatively, a user may include a business entity or group of people, rather than an individual person. Any of the users 102 may utilize a user device, which may include a conventional personal computer, a mobile user device, including a network-enabled mobile phone, VoIP phone, cellular phone, personal digital assistant (PDA), pager, network-enabled television, digital video recorder, such as TIVO®, and/or automobile. A user device configured to connect with the network 104, such as the general computer system or any of the components as described in FIG. 6. In alternate embodiments, there may be additional user devices, and additional intermediary networks that are established to connect the users 102 or user devices with the web server 106 and/or the requestor 108.

The network 104 may generally be enabled to employ any form of machine-comprehensible media for communicating information from one device to another and may include any communication method by which information may travel between devices. The network may be a network 626 as described in FIG. 6. For example, the network 104 may include one or more of a wireless network, a wired network, a local area network (LAN), a wide area network (WAN), a direct connection such as through a Universal Serial Bus (USB) port, and the like, and may include the set of interconnected networks that make up the Internet. The wireless network may be a cellular telephone network, a network operating according to a standardized protocol such as IEEE 802.11, 802.16, 802.20, published by the Institute of Electrical and Electronics Engineers, Inc., or WiMax network. Further, the network 104 may be a public network, such as the Internet, a private network, such as an intranet, or combinations thereof, and may utilize a variety of networking protocols now available or later developed including, but not limited to TCP/IP based networking protocols.

The web server 106 may be coupled directly with the requestor 108, and/or may be indirectly coupled with the requestor 108 through the network 104. The web server 106 or the requestor 108 may comprise a general computer system or any of the components as described below in FIG. 6. In one embodiment, the web server 106 may be accessible through the network 104 by the users 102 and/or by the requestor 108. Alternatively, the requestor 108 may be coupled with the web server 106, or the web server 106 may be the requestor 108, which is coupled with the users 102 through the network 104.

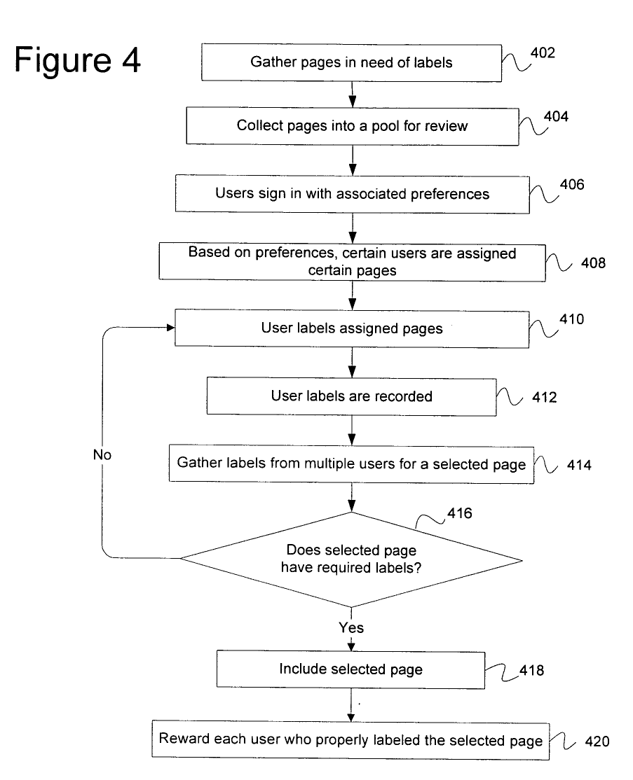

The web server 106 may facilitate or organize requests received from the requestor 108. In alternate embodiments, there may be a plurality of requesters 108 that are coupled with the web server 106 through the network 104. Each of the plurality of requestors may provide at least one request that they would like satisfied by at least one of the users 102. As discussed above, the request may also be referred to as a job, task, work, activity, assignment, review, or human review. A request may be anything that a requester 108 would like accomplished or completed by at least one user 102. In other words, a request may be a request for at least one user to provide a service for the requester 108. A request may include any service or information that a user 102 is able to provide. As described below in FIG. 4, the labeling of data, pages, or products may be a request that is completed by users 102 for a requestor 108.

The web server 106 may act as a web portal through which the users 102 and the requestor 108 may connect. The web server 106 may allow users 102 to select requests that they would like to work on, or the web server 106 may automatically assign requests to users 102. The web server 106 receives the requirements for a request from the requestor 108 and receives the qualifications from the users 102. User qualifications may include previous experience, education, training, test results, or rating based on previous completed requests. Based on the requirements and qualifications, the web server may match requests with at least one user who has the appropriate qualifications.

In an alternate embodiment, the web server 106 may be a virtual factory 206 as shown in FIG. 2. The virtual factory 206 may include a general computer system or any of the components as described below in FIG. 6. In one embodiment, the virtual factory 206 may be implemented in software, or may be a web interface. For example, the virtual factory 206 may be a web page that allows for the users 102 to log in and the requestors 108 to log in. The web page may operate to provide relevant information from the users 102 to the requestor 108 and from the requestor 108 to the users 102.

In particular, the requestor 108 may deposit requests with the virtual factory 206. The requests may include necessary qualifications and requirements. The users 102 connect with or log into the virtual factory 206 to select various requests to complete. The requests may specify requirements necessary for completion so that users 102 can determine if they are able to complete a particular request. Alternatively, the requestor 108 may have access to the available users 102 and their respective qualifications to be able to select the users 102 to complete the requestor's 108 request. Accordingly, the virtual factory 206 may be a passive host that merely allows for the transfer of requests from a requestor 108 to a user 102. Conversely, the web server 106 as described in FIG. 1 may be configured to actively select users 102 to be matched to particular requests or requesters 108. Likewise, the web server 106 may be configured to actively select a particular request from a requestor 108 and match it with at least one qualified user 102.

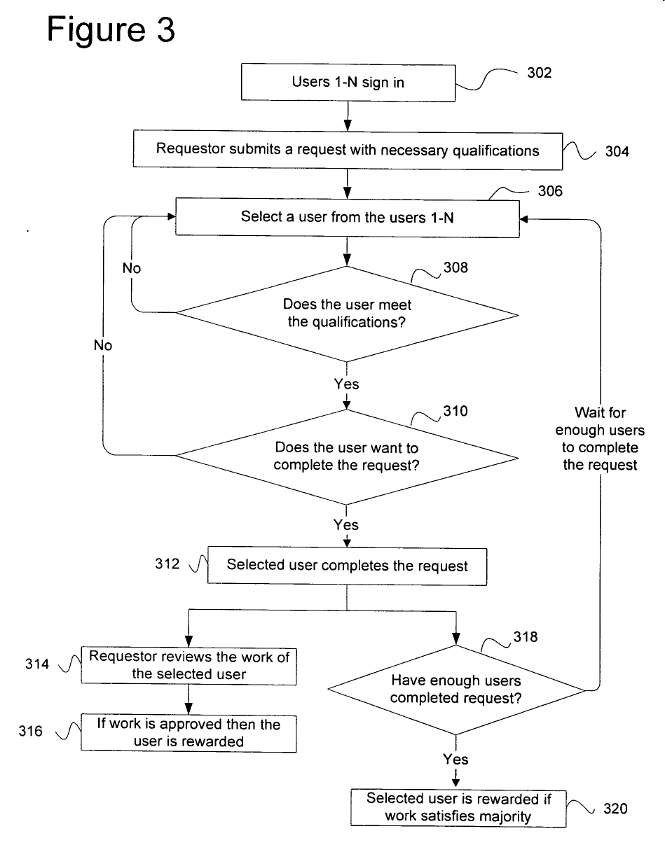

FIG. 3 is a flow chart illustrating one embodiment allowing for human responses to requests. In block 302, user 1 102₁ through user N 102_{N} connect with a requestor 108. As described above, the users 102 may log into a website or virtual factory 206, or the users 102 may be coupled with the requestor 108 through the web server 106. In block 304, the requestor 108 submits a request through the web server 106. The request may include details regarding what must be completed by the user 102 and also include the necessary qualifications that are required to complete the request. The web server 106 may receive the request from the requestor 108, or alternatively, a virtual factory 206 is established for the requestor 108 to deposit requests. The users 102 can view the deposited requests and corresponding requirements and notify the requestor 108 that a particular user 102 would like to complete the request. The description below will assume the request is transmitted through a web server 106 for simplicity.

In an alternate embodiment, the requester 108 may submit request through the web server 106 as in block 304 and the users then come to complete the requests. In particular, the users may sign in as in block 302 in response to the requests submitted as in block 304. Therefore, in one embodiment, the requests are submitted before the users sign in.

In block 306, a user is selected from the group of available users 102_{1-N} that are logged into or coupled with the requestor 108. In one embodiment, the selected user may be the user who actively volunteers to complete the request. For example, a user may view the requests and choose which requests he/she would like to complete. Alternatively, the requestor 108 may select the user to complete the request if there are multiple users interested in completing a request. The selected or volunteering user would like to complete a request to receive a reward. In block 308, a determination is made as to whether the chosen user satisfies the qualifications for the request. If the selected user does not meet the necessary qualifications, then a different user may be selected in block 306. The qualification requirement may let only the qualified users to do the task. For example, only qualified users may be given access to view the request. In block 308, if the chosen user does meet the requirements or qualifications of the requestor 108, then the chosen user may be given the option of being assigned the request. In block 310, if the chosen user does not wish to work on the request, then another user is selected in block 306. If the chosen user does wish to complete the request in block 310, then the user is assigned the request. The user must then complete the request in block 312.

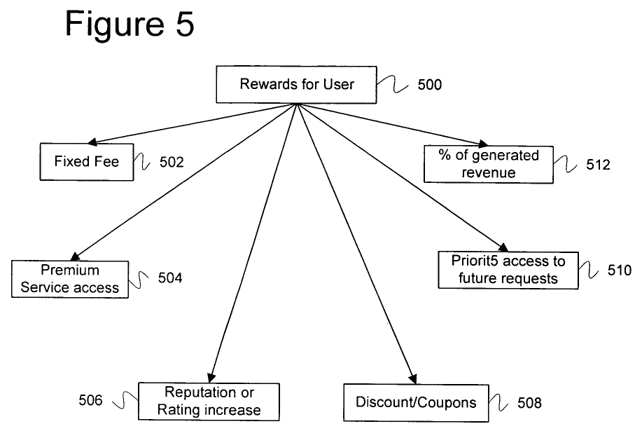

A reward may be associated with completion of the request or human response as shown in FIG. 5. In particular, once a user has earned a reward in block 500, there are various options for potential rewards. In block 502, the reward may be a fixed fee. For example, each request may be associated with a fee that is paid to the user upon completion. In block 504, the reward may be access to certain premium services offered by the requestor 108 or the web server 106. For example, a user who completes a certain number of requests may be able to access Internet content that is unavailable to others.

In block 506, the user may receive an increased rating or reputation associated with the user's completion of requests. The user may desire to compete with other user's to achieve a higher rating or reputation based on the number and quality of completed requests. With a reputation reward, users may participate as a competition to try to become the highest rated or best responder. A competition or contest with improved reputation as a reward may make the process seem like a game that users have fun participating in. In block 508, the user may receive discounts or coupons for completing requests. The discounts or coupons may be related to the requestor 108 or the web server 106. Likewise, the reward may be priority access to future requests as in block 510. A user who has successfully completed a request from a particular requestor 108 may receive priority access to future requests from that requestor 108 or other requesters 108.

One reward may be a percentage of generated revenue related to the completed request as in block 512. Any revenue that may be generated for the requestor 108 as a result of the completion of the request may be shared with the user who completed the request. For example, if the request is categorizing products for a shopping web page, then the user may receive a percentage of the profit from the product sale. The user may categorize the product by brand or product type and the user may receive a reward each time a user utilizes one of the categories to view the product. The completed requests may generate some direct values (e.g., pay per click for advertisements) or indirect values (improved relevancy or site quality) that may be shared with the user as discussed below.

Referring back to FIG. 3, the selected user has completed the request in block 312. After the requestor reviews the work in block 314, the user may be rewarded if the requestor 108 approves of the completed request as in block 316. Approval may be objective or subjective, such as an opinion or judgment by the requestor 108 of the quality or results of the completed request.

Alternatively, in block 318, a certain (minimum) number of users may be required to complete the same request that the selected user has completed. If enough users have not completed the request, then a reward is not available until enough users complete the request in block 312. If enough users have completed the request, then those users that satisfy the majority may be rewarded in block 320. In one embodiment, there may be a requirement that ten people complete a request and that at least seven of them agree on the completed result. Accordingly, the seven who agree on the completed request and will be rewarded, but the other three did not properly complete the request and will not be rewarded. A majority rule may be established in different ways. For example, more than 50% of the users must agree on the results. Alternatively, it may be the most common result is the majority. For example, if three out of ten agree on the results and each of the remaining seven have completely different results from the three and from each other, then the result from the three users satisfies the majority rule. Accordingly, the majority rule may require only that after a minimum number of users have completed the request, that the largest group of users with the same result are the correct users regardless of how many agreed. The majority rule may include a requirement that the result that includes a minimum number of users agreeing in the majority. For example, the first time ten users agree on a result, that result is deemed to be the majority or the correct result. There may be a cutoff time within which the minimum number of users must complete the request.

There may be the possibility of fraud where certain users may attempt to collect the rewards without actually doing the work. For example, a user may use a robot, or other machine learning mechanism to attempt to complete the request. Accordingly, fraud prevention techniques may be used to monitor and detect such users. For example, a user who consistently does not have correct completion of the requests, or who has an unusually high number of requests may be a sign of fraud. In one example CAPTCHA™, or another image mechanism may be used to ensure that a human has responded to the request. A letter-based image approach may be used to prevent robots because it may be relatively easy for humans to recognize the letters but it may be difficult for character recognition program to do so. Other ways to prevent robot or automated submissions may include the use of random images with known labels that are used to be labeled, so the system can detect whether the quality of the label submission is accurate by comparing it to the known labels. A failure to match the known labels may suggest the labeling is potentially done by an automated program.

FIG. 4 is a flow chart illustrating another embodiment allowing for human responses to requests. In particular, FIG. 4 is an example of a request that involves the labeling or categorization of data and the completion of that request by users. In particular, the request may be for the review of or labeling of data associated with product pages or web pages. For example, one request may include web pages of products for sale that need to be labeled and/or categorized with metadata to allow for proper indexing in a search engine database. A men's ADIDAS® shoe, may need to be labeled as apparel, shoe, men's, or ADIDAS, so that the product is associated with those labels. Machine learning (ML) techniques may not be able to accurately accomplish this request, so a human response or review may be necessary for accurate labeling of data or for verification of ML labeling.

Labeling may be used in a variety of other circumstances. In addition to categorizing a particular product or page, labeling may include developing keywords, attributes, concepts, or translations of existing data. For example, attributes may refer to the description associated with a product or page that is established by a user. In another example, for a product on sale, there may be many things we would like to extract, such as: gender, size, color, or style for apparel; or computer type, speed, memory size, hard disk size for a computer; or brand, size, kind, or color for athletic shoes.

The labeling of data may also be used for advertising purposes. Web pages may be categorized for a determination of which ads apply to them. For example, a search in a search engine may result in the display of advertisements that are related to the search based on the labeling of the search result data or search keyword. A search with targeted advertisements may be referred to as a “sponsored search.” The labeling or categorization of search terms or search results may be used to select the most relevant advertisements. Content Match® used by Yahoo!® targets specific advertisements based on the content of a page. The users may review the targeted advertisements that are displayed as a result of a search query or from Content Match® for a determination of their relevance. Advertisements that are most relevant are matched to a publisher's content page, in order to maximize certain objectives, such as click through rate. Human review can help improve the relevance by reviewing either the advertisements, the content pages, or by matching of the two.

There are at least two types on online advertisements marketed online, which rely on click through rate of the ad. One is a “sponsored search” in which ads shown with the search results when people do a search, and the other type of ad is “Content Match®,” which are the ads shown on a web page where the ads are supposedly relevant to the contents of the page. Matching may be relevant to either type of ads. In particular, for content match ads, there may be at least three kinds of tasks or labeling requests that a human may help with: 1) labeling the web page or what the page is about, 2) labeling the ads that are displayed (what the ads are about), and 3) labeling whether an ad is relevant to a web page and whether the ad is a good match or fit to show on the page. One example may be a page in a web site about high-tech gears, a human may label the page with “Sony DSLR-A100®”, and it may be a good match to include ads that are selling the “Sony SLR camera” or any other digital camera.

In block 402, pages are gathered that may need to be labeled or categorized. As discussed above, the pages may be product pages that need to be categorized, or the pages may need labeled for advertising purposes. For example, if the pages relate to baseball, then they should be labeled accordingly, so that the advertisements that are shown on the pages may also be related to baseball. The pages to be reviewed or labeled are collected into a pool for review in block 404. Users are logged into or connected with the system in block 406. Each user has certain qualifications or preferences regarding the reviewing or labeling he/she is capable of. In block 408, certain users may be assigned certain pages for review and/or labeling. The qualifications of the users and the requirements for the labeling request may determine which users are assigned to which pages in block 408. As discussed above, the web server 106 may assign requests to users, or the users 102 may choose requests, or the requester 108 may choose users 102.

The assigned users then label the pages or review the page labels in block 410. The labels or results of the review are recorded in block 412. The labels and results from multiple users are gathered and recorded for a given page in block 414. In block 416, a determination is made as to whether the page has the required labels. In other words, a determination is made as to whether the results of the labeling are correct and/or satisfy some form of a majority rule. In particular, there may be a minimum number of users that must agree on the label for a particular page for that label to be accepted. As discussed above, there may be a majority requirement for a determination of whether any label is correct. If the label does not satisfy the minimum requirements, then users continue to generate labels for the page as in block 410. If the label is correct, then in block 418, the label is included with or incorporated into the page. In the case of a product page, it will include the label or category in its description, or a consumer may be able to find the product through the category. In block 420, the users who correctly label the page are rewarded as discussed in FIG. 5.

In one embodiment, if the reward is based on a percentage of revenue, then the user is paid based on the usage of the label. For a product page that is labeled with a category, such as a shoe that is labeled as a running shoe, for every visitor that views the product page by viewing the pages associated with the category running shoe, the users who established the labels may receive a reward. A reward may be for visitors viewing of the product page, or alternatively the reward may be based on whether a visitor purchases the product from the page. Rewards may be when a visitor uses the label developed by the user to find the product; however, if different users come up with different labels, only those users whose labels are used may get paid.

In the case of a web page that is categorized for advertisements, the user who correctly categorizes the web page may receive a share of the advertising revenue. For example, if a web page is categorized as baseball, then advertisements related to baseball would be included in the page. Each time the advertisements are selected or clicked on, the users who correctly categorized the web page may be eligible for a portion of the advertising revenue. In addition, the set of users receiving rewards may include those who help label the web page, those who help label the ads, and if applicable those who determine whether the ad is relevant to the web page. The distribution of the revenue as a reward may be based on type of labels and may vary between web pages.

In the case of a web page that is categorized for relevant advertisements, the web server 106 may be an advertisements server that associates or links relevant advertisements with content and web pages. The ad server may provide a platform for selection, optimization, and/or distribution of advertisements for inclusion in pages, such as web pages. In such a case, the requestor 108 may be the ad server that is submitting requests for users to complete.

There may be additional tasks that may require or benefit from a human review or human completion as discussed above. In particular, one additional example may include tagging. A label and/or tag may serve as useful meta-data to complicate objects, which may be difficult for computer to understand. The objects, such as images or video clip may be easy for a human to understand. For example, humans can label “Pepsi funny commercial Jackie Chan” for a video clip. The meta information may then be collected and used in video search in this case. Another example is categorization, which may be used for better searching, navigation and organization. A third example may be attribute extraction for extracting important/useful information from a page or product. A fourth example may be ratings, such as user reviews/feedback on books, movies, hotels, etc. An application may utilize the human ratings as quality for ranking search results. As a fifth example, matching may include judging whether two objects or labels refer to the same thing. For example, two different hotel addresses may actually refer to the same hotel. A sixth example is for translations. Given a text in one language, a human may be needed to translate it into another language. A seventh example may be training data for a machine learning system. All the data collected may be used to train an automated system to perform certain tasks.

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices. As described above any of the users 1-N 102_{1-N} may use a general computer system 600 or at least one component discussed below. Likewise, the web server 106, requestor 108, and/or virtual factory 206 may be a general computer system 600 or at least one component discussed below.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via a bus 608. The memory 604 may be a main memory, a static memory, or a dynamic memory. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 604 includes a cache or random access memory for the processor 602. In alternative embodiments, the memory 604 is separate from the processor 602, such as a cache memory of a processor, the system memory, or other memory. The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the programmed processor 602 executing the instructions stored in the memory 604. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 600 may further include a display unit 614, such as a liquid crystal display (LCD), an organic light emitting diode (OLED), a flat panel display, a solid state display, a cathode ray tube (CRT), a projector, a printer or other now known or later developed display device for outputting determined information. The display 614 may act as an interface for the user to see the functioning of the processor 602, or specifically as an interface with the software stored in the memory 604 or in the drive unit 606.

Additionally, the computer system 600 may include an input device 616 configured to allow a user to interact with any of the components of system 600. The input device 616 may be a number pad, a keyboard, or a cursor control device, such as a mouse, or a joystick, touch screen display, remote control or any other device operative to interact with the system 600.

In a particular embodiment, as depicted in FIG. 6, the computer system 600 may also include a disk or optical drive unit 606. The disk drive unit 606 may include a computer-readable medium 610 in which one or more sets of instructions 612, e.g. software, can be embedded. Further, the instructions 612 may embody one or more of the methods or logic as described herein. In a particular embodiment, the instructions 612 may reside completely, or at least partially, within the memory 604 and/or within the processor 602 during execution by the computer system 600. The memory 604 and the processor 602 also may include computer-readable media as discussed above.

The present disclosure contemplates a computer-readable medium that includes instructions 612 or receives and executes instructions 612 responsive to a propagated signal, so that a device connected to a network 620 can communicate voice, video, audio, images or any other data over the network 620. Further, the instructions 612 may be transmitted or received over the network 620 via a communication port 618. The communication port 618 may be a part of the processor 602 or may be a separate component. The communication port 618 may be created in software or may be a physical connection in hardware. The communication port 618 is configured to connect with a network 620, external media, the display 614, or any other components in system 600, or combinations thereof. The connection with the network 620 may be a physical connection, such as a wired Ethernet connection or may be established wirelessly as discussed below. Likewise, the additional connections with other components of the system 600 may be physical connections or may be established wirelessly.

The network 620 may include wired networks, wireless networks, or combinations thereof. The wireless network may be a cellular telephone network, an 802.11, 802.16, 802.20, or WiMax network. Further, the network 620 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method for distribution and completion of a request comprising:
receiving information from a plurality of participants;
making the request for completion available to the plurality of participants;
receiving an acknowledgment from an active participant of the plurality of participants that the active participant will complete the request;
receiving the completed request from the active participant; and
rewarding the active participant based on revenue generated from the completed request upon approval of the completed request.

2. The method of claim 1 wherein the request comprises determining at least one of labels, categories, attributes, translations, or combinations thereof.

3. The method of claim 1 wherein the making the request for completion available includes posting the request on a network accessible by at least some of the plurality of participants.

4. The method of claim 3 wherein the active participant views the request on the network and submits an acknowledgement that the active participant would like to complete the request.

5. The method of claim 1 wherein the request comprises categorizing an advertisement or a page.

6. The method of claim 5 wherein the revenue generated is revenue from the advertisement.

7. The method of claim 1 further comprising comparing the completed request with results from other participants of the plurality of participants completing the request.

8. The method of claim 7 wherein the comparison includes a determination whether the completed request matches a majority of the results from the other participants.

9. In a computer readable storage medium having stored therein data representing instructions executable by a programmed processor for participant response, the storage medium comprising instructions for:
receiving information from a plurality of participants;
receiving a task for the participant response;
identifying at least one of the plurality of participants to perform the task;
receiving a result of the completed task from the identified participant;
comparing the result of the completed task from the identified participant with results of completed tasks from other participants of the plurality of participants; and
rewarding the identified participant when the completed task satisfies a majority rule based on the comparison of the completed task with the results of the completed tasks from the other participants.

10. The instructions of claim 9 wherein the request comprises determining at least one of labels, categories, attributes, translations or combinations thereof.

11. The instructions of claim 9 wherein the majority requirement requires a minimum number of chosen labels and the satisfaction of the majority requirement requires the chosen labels from the identified at least one user matches a majority of the chosen labels from other users.

12. The instructions of claim 9 wherein the reward comprises a portion of the revenue generated from the completed request.

13. A method for human review comprising:
collecting items which need to be labeled;
identifying at least one user to label at least one of the collected items;
receiving chosen labels from the identified at least one user for the at least one of the collected items;
comparing the chosen labels from the identified at least one user with chosen labels from other users; and
rewarding the identified at least one user if the chosen labels satisfy a majority requirement.

14. The method of claim 13 wherein the items include at least one of web pages, product pages, advertisements, or combinations thereof.

15. The method of claim 13 wherein the majority requirement requires a minimum number of chosen labels from a plurality of users and the satisfaction of the majority requirement requires the chosen labels from the identified at least one user matches a majority of the chosen labels from other users.

16. The method of claim 13 wherein the reward comprises a portion of the revenue generated from the completed request.

17. (canceled)

18. (canceled)

19. (canceled)

20. The method of claim 21 further comprising selecting a plurality of available users for completing the request.

21. A method for distributing requests to users comprising:
receiving a qualification for each of a plurality of available users;
providing a request to be completed by at least one of the plurality of available users;
receiving notification from one of the available users that the notifying user will complete the request;
receiving a result from the completed request from the notifying user;
comparing the result of the completed request from the notifying user with other results from other users completing the request; and
rewarding the notifying user if the result of the completed request from the notifying user compares with a percentage of the other results from the other users completing the request.

22. The method of claim 21 further comprising transmitting the request to the notifying user.

23. The method of claim 21 wherein the reward is a portion of the revenue generated by the completed request.

24. The method of claim 21 wherein the request comprises determining at least one of labels, categories, attributes, translations or combinations thereof.

25. A system for identifying and rewarding a selected participant upon completing a task comprising:
a network;
a web server coupled with the network and configured to receive information from a plurality of participants; and
a requestor coupled with at least one of the network, the web server, or combinations thereof, the requestor configured to provide the task;
wherein at least one of the plurality of participants is identified to complete the task and the identified participant is rewarded based on revenue generated by the completed task upon approval by the requestor of the completed task.

26. The system of claim 25 wherein the approval of the requestor comprises comparing the completed task from the identified participant with a minimum number of completed tasks from other participants.

27. The system of claim 25 wherein the information from the plurality of participants comprises qualifications for each of the plurality of participants.
